(19) United States
(12) Patent Application Publication
(10) Pub. No.: US 2022/0291573 A1
(43) Pub. Date: Sep. 15, 2022

(54) Point of View Camera Mount

(71) Applicant: Chronos X LLC, Orlando, FL (US)

(72) Inventor: Benjamin Hilliard, Eustis, FL (US)

(21) Appl. No.: 17/694,024

(22) Filed: Mar. 14, 2022

Related U.S. Application Data
(60) Provisional application No. 63/161,192, filed on Mar. 15, 2021.

(51) Int. Cl. G03B 17/56; F16M 13/02

(52) U.S. Cl. CPC G03B 17/561; F16M 13/02; F16M 11/041

(57) ABSTRACT

An assembly for using a POV camera by means of a mount. The mount generally includes a cotter pin and a spring for further securing the camera to the mount. The mount disclosed herein is comprised of aluminum, versus prior known plastic, and used a quick release spring plunger. Further, a tether loop on the mount acts as a failsafe to prevent camera loss.

### CROSS REFERENCE TO RELATED APPLICATIONS

This application claims priority and benefit to Provisional Patent Application Ser. No. 63/161,192 filed on Mar. 15, 2021.

### TECHNICAL FIELD

The present specification generally relates to camera mounts and, more specifically, to a device for mounting a point-of-view (POV) camera to a pole, helmet, vehicle, body or other equipment.

### BACKGROUND

Typically, POV camera mounts include a j-hook design in connection with a plastic mount. These mounts oftentimes do not perform to the desired level, especial in high intensity activities.

Accordingly, there exists a need in the art to provide an improved camera mount overcoming the aforementioned disadvantages.

### SUMMARY

A quick release mount assembly for mounting a point-of-view (POV) camera, the assembly having a base, a mount removably connected to the base, the mount having a camera connector configured to connect directly to the POV camera, and a spring plunger mounted in the mount, the spring having a ball and corresponding spring, the spring plunger compressed when sliding through the base, the spring plunger then decompresses once the mount is slid into place thereby securing the mount to the base. In some embodiments, the assembly further includes a pin removably connected to the mount, the mount having a hole extending through the mount and the base, the mount is removable from the base when the pin is removed. The pin may be a cotter pin. In some embodiments, the base is aluminum. The mount may further include an aperture to connect a tether thereto.

A quick release mount assembly for mounting a point-of-view (POV) camera, the assembly having a base, a mount removably connected to the base, the mount having a camera connector configured to connect directly to the POV camera, and a pin removably connected to the mount, the mount having a hole extending through the mount and the base, wherein the mount is removable from the base when the pin is removed. In some embodiments, a spring plunger mounted in the mount, the spring plunger movable between a locked position and a release position upon pressing of a button, wherein the mount is removable from the base when the spring plunger is in a release position. The pin may be a cotter pin. In some embodiments, the base is aluminum. The mount may further include an aperture to connect a tether thereto.

A quick release mount assembly for mounting a point-of-view (POV) camera, the assembly includes a base, a mount removably connected to the base, the mount having a camera connector configured to connect directly to the POV camera, a spring plunger mounted in the mount, the spring plunger movable between a locked position and a release position upon pressing of a button, wherein the mount is removable from the base when the spring plunger is in a release position, and a pin removably connected to the mount, the mount having a hole extending through the mount and the base, the mount is removable from the base when the pin is removed. The pin may be a cotter pin. In some embodiments, the base is aluminum. The mount may further include an aperture to connect a tether thereto.

### BRIEF DESCRIPTION OF THE DRAWINGS

The embodiments set forth in the drawings are illustrative and exemplary in nature and not intended to limit the subject matter. The following detailed description of the illustrative embodiments can be understood when read in conjunction with the following drawings, where like structure is indicated with like reference numerals and in which:

FIG. 1 depicts a perspective view of the mount having improved connection features according to one or more embodiments shown and described herein;

FIG. 2 depicts a side view of the mount having improved connection features according to one or more embodiments shown and described herein;

FIG. 3 depicts a perspective view of the base of the mount having improved connection features according to one or more embodiments shown and described herein;

FIG. 4 depicts an underside perspective view of the mount having improved connection features according to one or more embodiments shown and described herein;

FIG. 5 depicts a side view of the mount having improved connection features according to one or more embodiments shown and described herein;

FIG. 6 depicts a perspective view of the mount connected to a camera according to one or more embodiments shown and described herein;

FIG. 7 depicts perspective view of the mount disconnected from the base according to one or more embodiments shown and described herein;

FIG. 8 depicts perspective view of the mount connected to the base according to one or more embodiments shown and described herein;

FIG. 9 depicts a front view of the mount disconnected from the base according to one or more embodiments shown and described herein;

FIG. 10 depicts a perspective view of the base and the mount according to one or more embodiments shown and described herein;

FIG. 11 depicts a perspective view of the mount assembly according to one or more embodiments shown and described herein;

FIG. 12 depicts a perspective view of the mount assembly with the cotter pin installed according to one or more embodiments shown and described herein;

FIG. 13 depicts a perspective view of the mount assembly with the cotter pin installed according to one or more embodiments shown and described herein;

FIG. 14 depicts an underside view of the mount according to one or more embodiments shown and described herein; and

FIG. 15 depicts a perspective view of the base showing the protrusion that connects with the channel of the mount according to one or more embodiments shown and described herein.

### DETAILED DESCRIPTION

The apparatus of the present specification discloses an assembly for using a POV camera by means of a mount. The mount generally includes a cotter pin and a spring for further securing the camera to the mount. The mount disclosed herein is comprised of aluminum, versus prior known plastic, and uses a quick release spring plunger. Further, a tether loop on the mount acts as a failsafe to prevent camera loss. Further, the tether may be connected to a secondary tether mount for additional protection against loss.

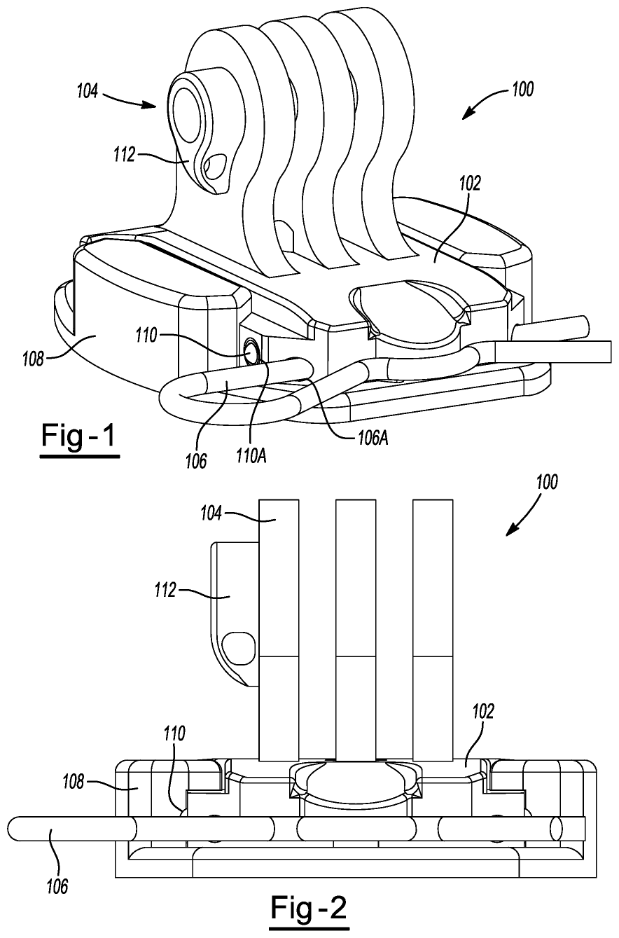

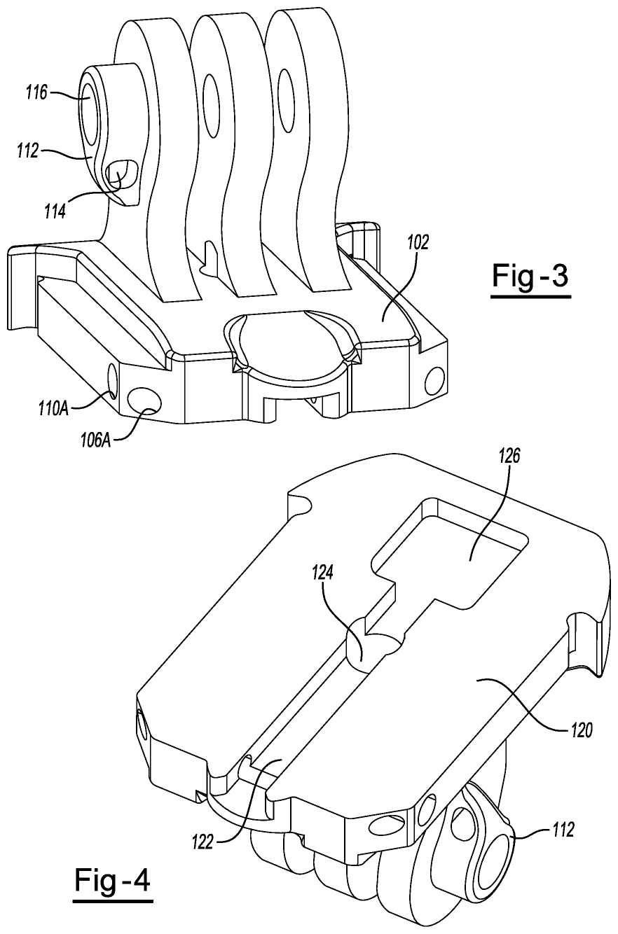

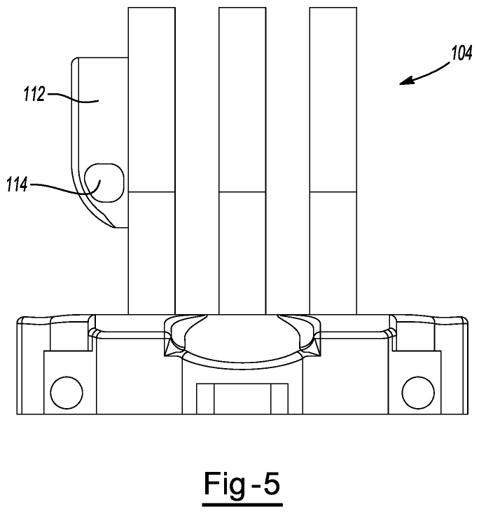

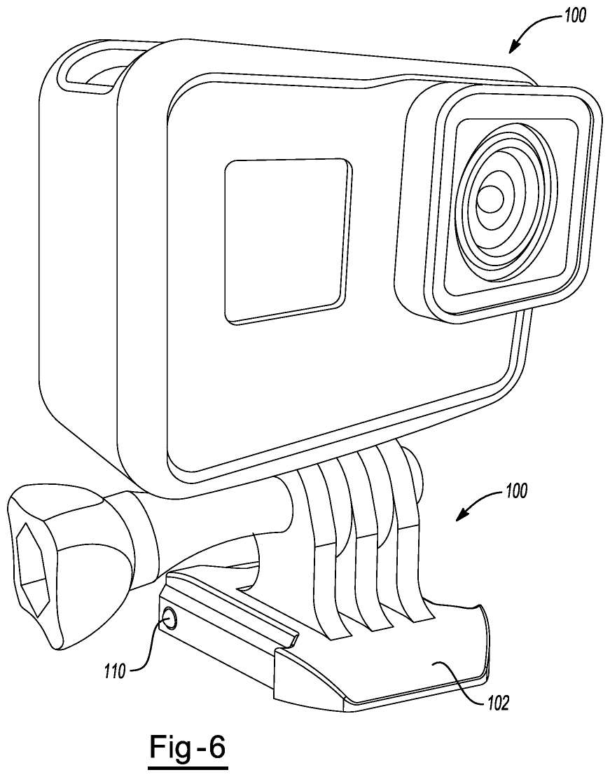

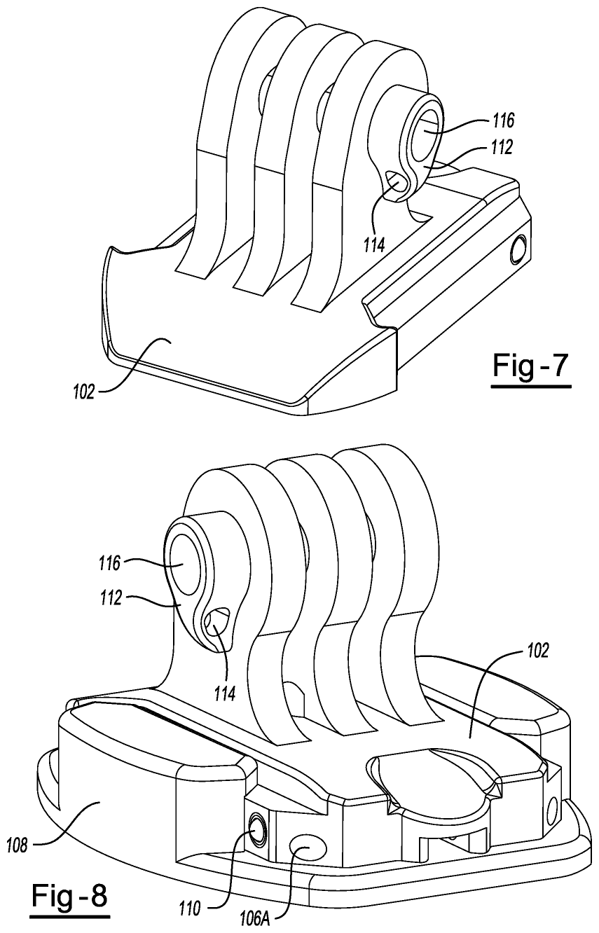

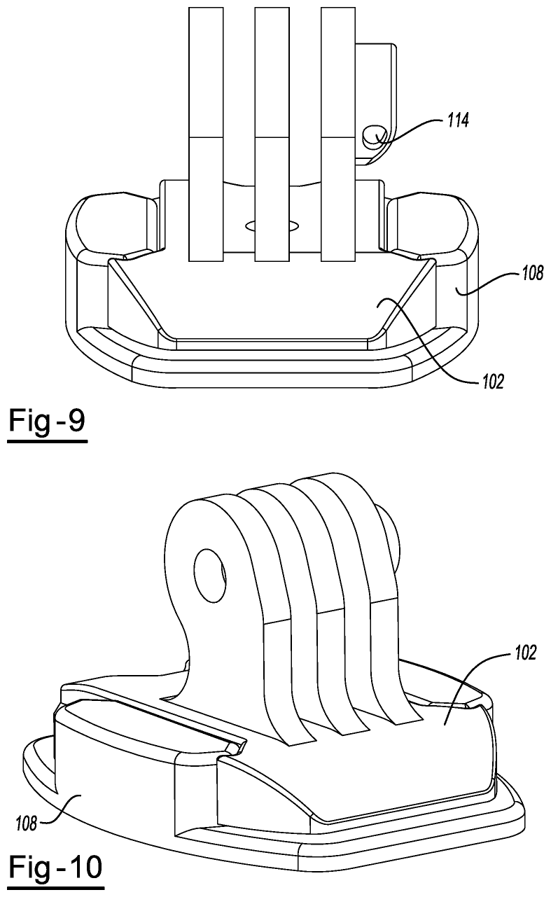

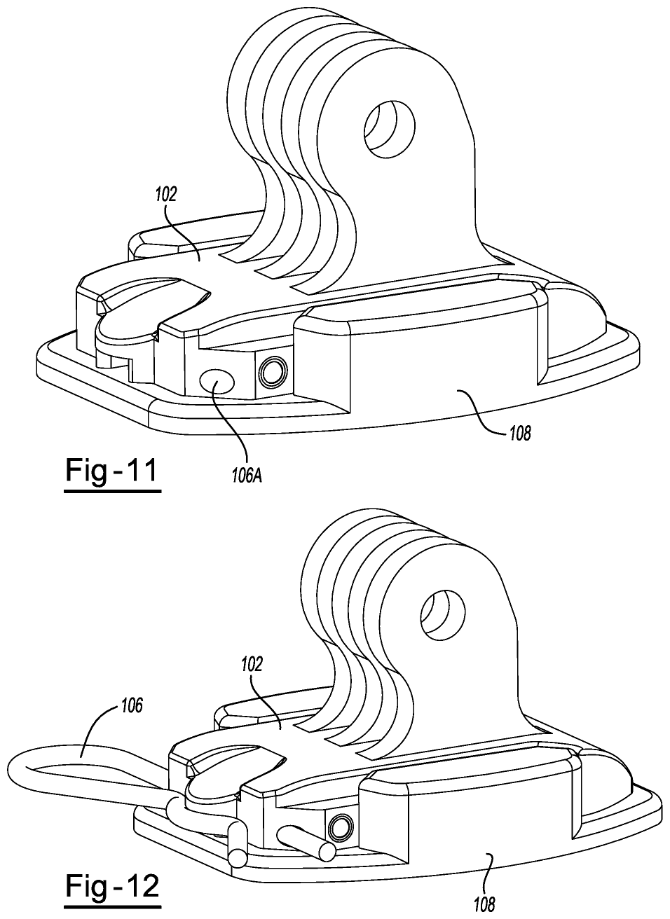

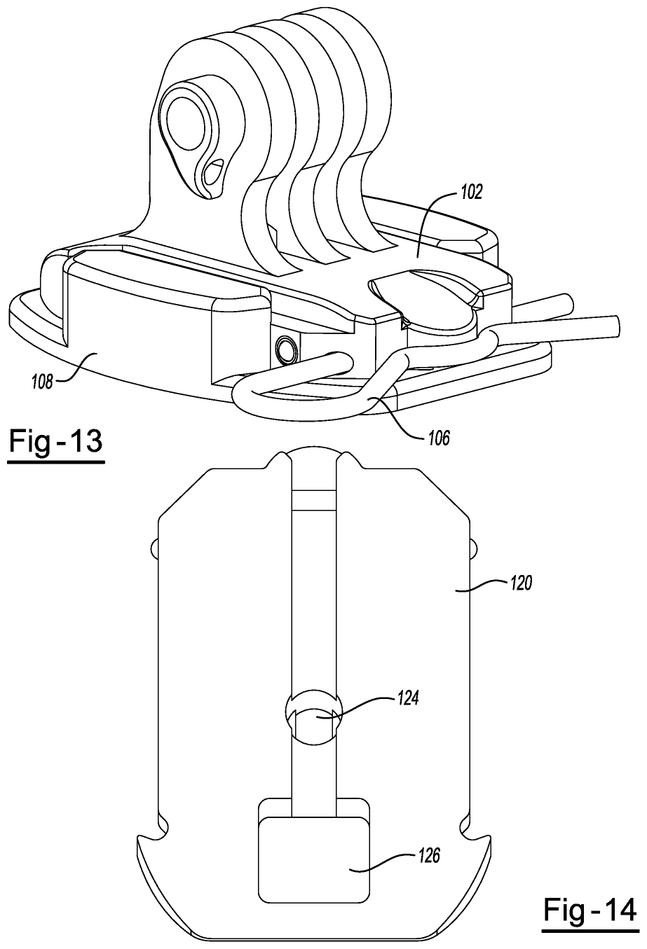

FIGS. 1-14 depict a mount assembly 100 having a mount portion 102 and a base 108. The mount portion 102 is configured to connect directly to a POV camera 200, such as illustrated in FIG. 6. The mount portion 102 includes a connector portion 104 configured to connect directly to the POV camera. The mount 104 includes a tether portion 112 configured to attach a tether directly thereto. The other end of the tether is to be connected to the POV camera itself as a final safety measure to ensure the user does not lose their camera.

The base 102 of the assembly 100 includes a connection means to connect the POV camera to the mount assembly. First, a cotter pin 106 is used to secure the POV camera to the base 102. The cotter pin 106 extends through an aperture 106A extending through the entire base 102 of the assembly 100. The base of the mount is also form-fitted to the middle section of the cotter pin to further secure the cotter pin in place. The cotter pin is used as a secondary fail safe for the mount. The primary being the spring plungers as the mount can be used without the cotter pin.

The cotter pin 106, in this embodiment, is made of a metal, such as aluminum. However, in other embodiments, the cotter pin 106 may be made of any suitable resilient material capable and having sufficient strength and resiliency to hold the POV camera to the mount assembly 100.

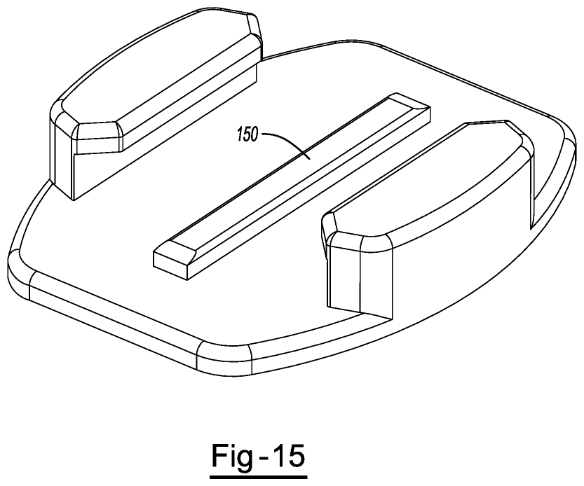

The primary structure of securement is the quick release plungers 110 and can be used without the cotter pin 106. The quick release plungers 110 allow the user to simply press the plunger to release a detent which releases the POV camera (once the cotter pin 106 is also removed). The quick release plungers 110 extend into the base 102 at the apertures 110A. The quick release plungers 110 enable the user to quickly and efficiently remove the POV camera without additional screws or hooks, such as in the prior known models. The ball and spring of the plunger 110 are compressed when sliding thru the base then decompress once the mount reaches the end to hold it in place. The best way to disengage the spring plungers is to push the base 102 of the quick release mount forward back thru the FIG. 15 base.

Further, the base 102 of the assembly 100 is made of aluminum. The higher strength and resilient aluminum has superior performance characteristics as compared to the currently known plastic. Further, the aluminum enables the quick release plungers 110 and the cotter pin 106 to retain robustness without the worry of breaking. The apertures 106A and 110A extending through the base 102 would traditionally weaken the base 102 if the base was made of a plastic. The aluminum composition of the base 102 enables the apertures 106A and 110A to continue to function without the worry of breakage of the base 102 of the assembly 100.

The base 102 further includes a raised protrusion 150 configured to connect with the channel 124, 126. The channel 124 uses this raised protrusion 150 to guide the mount thru the quick release base 102. The end portion 126 ensures that the quick release mount does not travel too far and locks the quick release mount in place with the spring plungers.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any Utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

What is claimed is:

1. A quick release mount assembly for mounting a point-of-view (POV) camera, the assembly comprising:
a base;
a mount removably connected to the base, the mount having a camera connector configured to connect directly to the POV camera; and
a spring plunger mounted in the mount, the spring having a ball and corresponding spring, the spring plunger compressed when sliding through the base, the spring plunger then decompresses once the mount is slid into place thereby securing the mount to the base.

2. The quick release mount assembly of claim 1 wherein the assembly further includes a pin removably connected to the mount, the mount having a hole extending through the mount and the base, the mount is removable from the base when the pin is removed.

3. The quick release mount assembly of claim 2 wherein the pin is a cotter pin.

4. The quick release mount assembly of claim 1 wherein the base is aluminum.

5. The quick release mount assembly of claim 1 wherein the mount further includes an aperture to connect a tether thereto.

6. A quick release mount assembly for mounting a point-of-view (POV) camera, the assembly comprising:
a base;
a mount removably connected to the base, the mount having a camera connector configured to connect directly to the POV camera; and
a pin removably connected to the mount, the mount having a hole extending through the mount and the base;
wherein the mount is removable from the base when the pin is removed.

7. The quick release mount assembly of claim 6 wherein a spring plunger mounted in the mount, the spring having a ball and corresponding spring, the spring plunger compressed when sliding through the base, the spring plunger then decompresses once the mount is slid into place thereby securing the mount to the base.

8. The quick release mount assembly of claim 6 wherein the pin is a cotter pin.

9. The quick release mount assembly of claim 6 wherein the base is aluminum.

10. The quick release mount assembly of claim 6 wherein the mount further includes an aperture to connect a tether thereto.

11. A quick release mount assembly for mounting a point-of-view (POV) camera, the assembly comprising:
a base;
a mount removably connected to the base, the mount having a camera connector configured to connect directly to the POV camera;
a spring plunger mounted in the mount, the spring having a ball and corresponding spring, the spring plunger compressed when sliding through the base, the spring plunger then decompresses once the mount is slid into place thereby securing the mount to the base; and
a pin removably connected to the mount, the mount having a hole extending through the mount and the base, the mount is removable from the base when the pin is removed.

12. The quick release mount assembly of claim 11 wherein the pin is a cotter pin.

13. The quick release mount assembly of claim 11 wherein the base is aluminum.

14. The quick release mount assembly of claim 11 wherein the mount further includes an aperture to connect a tether thereto.
